(19) United States
(12) Patent Application Publication
(10) Pub. No.: US 2022/0410354 A1
(43) Pub. Date: Dec. 29, 2022

(54) FASTENER DELIVERY TOOLS WITH GUIDE ASSEMBLIES, METHODS AND SYSTEMS

(71) Applicant: SIMPSON STRONG-TIE COMPANY INC., Pleasanton, CA (US)

(72) Inventors: Benjamin D. NIBALI, Maryville, TN (US); Kristo KUKK, Knoxville, TN (US); Kristopher C. HALL, Maryville, TN (US); Jeremy Scott PARK, Gallatin, TN (US); Adam TILLINGHAST, Nashville, TN (US)

(73) Assignee: SIMPSON STRONG-TIE COMPANY INC., Pleasanton, CA (US)

(21) Appl. No.: 17/809,112

(22) Filed: Jun. 27, 2022

Related U.S. Application Data
(60) Provisional application No. 63/215,597, filed on Jun. 28, 2021.

(51) Int. Cl. B25B 23/04; B25B 21/00

(52) U.S. Cl. CPC B25B 23/04; B25B 21/002; B25B 23/005

(57) ABSTRACT

Elongated fastener driving apparatuses are disclosed. The drivers are operable to quickly and accurately install fasteners from a standing position on, for example, a floor surface.

### CROSS-REFERENCE

This application claims the benefit of U.S. Provisional Application No. 63/215,597, filed Jun. 28 2021, entitled FASTENER DELIVERY TOOLS WITH GUIDE ASSEMBLY, METHODS AND SYSTEMS which application is incorporated herein in its entirety by reference.

### BACKGROUND

The disclosure relates to elongated member driving apparatus, including a driving apparatus that assures correct orientation of a fastener.

Fastener driving tools are known in the art. Such tools are typically electric-actuated tools for driving fasteners through a surface, such as a wood deck, a metal deck or metal roof. The fasteners that are driven include, for example, a shank having a self-tapping, self-driving or self-drilling tip at one end and head integral with the other end of the shank. A sealing washer can also be positioned on the shank with an interference fit.

Known fastener-driving tools generally include a driver such as an electric-actuated driver that is mounted to telescoping tubes. A first tube (upper or outer tube) is stationary relative to the driver and a second (lower or inner tube) telescopes relative to the upper tube. A shaft is mounted to the driver and extends through the tubes. The lower tube telescopes relative to the upper tube to permit movement of the driver shaft relative to a distal end of the lower tube. An end of the shaft includes, for example, a hex or socket-like element to engage the fastener head for driving. The lower tube telescopes to permit movement between a retracted position and a contracted position. In the retracted or extended position, a fastener is loaded onto an end of the shaft for driving into the surface. In the contracted position, the fastener is driven from the tool outwardly, through the distal end of the lower tube, into the surface.

Fastener driving tools include, for example, a spring positioned between the tubes to urge the tubes and thus the tool into the retracted or loading position. In some driving tools, the lower tube is fitted immediately within the upper tube. Although this assures proper alignment of the tubes relative to one another and straight movement of the fastener, there is surface-to-surface contact of the tubes which may be undesirable.

Generally, a stop is positioned on the end of the upper tube that cooperates with a stop positioned along the length of the lower tube. This limits that travel of the tubes relative to one another and assures that the fastener is properly driven into the surface. That is, the stops are positioned relative to one another so that the fastener is driven a predetermined amount into the surface.

Known fastener driving tools include a nosepiece assembly that supports the fastener prior to and as it is engaged by the driver shaft (e.g., socket-like element). An opening in the nosepiece provides a track or path through which the fastener is driven from the tool.

One drawback to current solutions is that fasteners that are longer than 3 inches and/or larger than #10 in diameter cannot easily be installed from a standing position with currently available tools. Additionally, if the wrong fastener is loaded, or is loaded in an incorrect position (e.g., head first), the fastener cannot be easily removed from existing driving tools.

Accordingly, there is a need for a fastener driving tool that can install structural screws which is both ergonomic for the user to use in a standing position and allows for efficient installation. Additionally, what is needed is a fastener driving tool that allows for easy removal of fasteners from the driving tool prior to installation. What is also needed is also needed is a fastener driving tool which is operable to provide improved delivery, alignment and installation of fasteners, including driving fasteners into a preformed hole.

### SUMMARY

Disclosed are fastener driving tools and methods operable to install structural screws which is both ergonomic for the user to use in a standing position and allows for efficient installation. Also disclosed are fastener driving tools that allows for easy removal of fasteners from the driving tool prior to installation. Additionally, the disclosed fastener driving tools and which is operable to provide improved delivery, alignment and installation of fasteners, including driving fasteners into a preformed hole.

Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
U.S. Pat. No. 3,960,191 A dated Jun. 1, 1976 to Murray;
U.S. Pat. No. 4,397,412 A dated Aug. 9, 1983 to Dewey;
U.S. Pat. No. 5,058,464 A dated Oct. 22, 1991 to McGovern et al.;
U.S. Pat. No. 6,341,542 B1 dated Jan. 29, 2002 to Ade et al.;
U.S. Pat. No. 6,622,596 B2 dated Sep. 23, 2003 to Janusz et al.;
U.S. Pat. No. 6,729,522 B2 dated May 4, 2004 to Hempfling et al.;
U.S. Pat. No. 6,769,332 B2 dated Aug. 3, 2004 to Muro;
U.S. Pat. No. 8,220,367 B2 dated Jul. 17, 2012 to Hsu;
U.S. Pat. No. 8,356,534 B2 dated Jan. 22, 2013 to Hale et al.;
U.S. Pat. No. 8,869,656 B2 dated Oct. 28, 2014 to Desmond et al.;
U.S. Pat. No. 10,421,176 B2 dated Sep. 24, 2019 to Vandenberg;
US 2006/0236815 A1 dated Oct. 26, 2006 to Beecherl et al.;
US 2004/0226977 A1 dated Nov. 18, 2004 to Hofbrucker et al.;
WO 2011/005996 A2 dated Jan. 13, 2011 to Vempati et al.;
Black and Decker, Screw Feeder Screwdriver Extension Attachment, available from https://www.blackanddecker.com/product-repository/products/2015/02/01/00/20/fs100sf (accessed June 2021);
Hitachi SuperDrive Sub-Floor and Decking Screwgun Lets You Stand Up and Work, available from https://toolguyd.com/hitachi-superdrive-sub-floor-deck-screwgun/(accessed June 2021);
PAM P13KDE Stand-up Screwgun Kit includes 2500 RPM 6.5A Milwaukee Screwgun, Dedicated Extension System and Case, available at https://www.bestmaterials.com/detail.aspx?ID=17135 (accessed June 2021);
Senco DS440-AC 3 in. Attachment Kit, available from https://www.homedepot.com/p/Senco-DS440-AC-3-in-Attachment-Kit-with-4-000-RPM-Screwdriver-6W0011N/206620154 (accessed June 2021); and
Simpson Strong-Tie, Quik Drive Auto-Feed Screw Driving Systems, available from https://strongtie.co.nz/products/quik-drive-auto-feed-screw-driving-systems (accessed June 2021).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A illustrates a power driver;

FIG. 1B illustrates a power driver in combination with a fastener delivery tool from an upper perspective facing a work surface;

FIGS. 1C-I illustrate a power driver in combination with a fastener delivery tool from different views;

FIG. 1J is an exploded view of a fastener delivery tool;

FIG. 2A illustrates a side partial perspective view of a loading assembly of the fastener delivery tool;

FIG. 2B illustrates an exploded view of the loading assembly of FIG. 2A;

FIG. 2C is a view of a power driver in combination with the fastener delivery tool including the loading assembly of FIG. 2A;

FIG. 3 is an exploded view of a driver shaft assembly of the fastener delivery tool;

FIGS. 4A-E illustrate a portion of the loading assembly of the fastener delivery tool of FIG. 2 illustrating a shifting process for shifting the fastener during fastener loading;

FIG. 4F illustrates a fastener entering the drop tube of the fastener delivery tool of FIG. 2;

FIG. 4G illustrates a fastener leaving the drop tube of the fastener delivery tool of FIG. 2 and entering the catch assembly;

FIG. 4H illustrates a fastener resting in the jaws of the drop tube of the fastener delivery tool of FIG. 2 with the catch aligned with the drop tube;

FIG. 4I illustrates a side view of the fastener delivery tool of FIG. 2 with the bottom assembly with the toggle in a first orientation;

FIGS. 5A-M illustrate a jaw assembly for delivery tool of FIG. 1;

FIG. 6A illustrates a fastener delivery tool engaging a work surface;

FIG. 6B illustrates a screw catch aligned with the bit and the drive shaft;

FIG. 6C illustrates a close-up of the distal end of the screw catch aligned with the bit and the drive shaft of FIG. 6B;

FIGS. 7A-F illustrate nose pieces for the fastener delivery tools including partial cross-sections, an external view, and an exploded view;

FIGS. 8A-C further illustrate the angled nose piece for the fastener delivery tool; and

FIGS. 9A-B further illustrate the flat nose piece for the fastener delivery tool.

### DETAILED DESCRIPTION

As disclosed herein, a fastener delivery tool 100, 200 is provided that comprises a loading assembly. The loading assembly comprising a feed tube 150, 250 that is operable to receive a fastener 40 at a first end of the feed tube 150, 250 and deliver the fastener 40 at a second end of the feed tube 150, 250. A driver shaft assembly 300 is also provided that is operable to engage a power driver 110, such as a drill, at a first driver shaft assembly end and receive the fastener 40 from the feed tube 150, 250. Both the shift assembly 180 and timing controller 236 are provided to control the speed at which the fastener 40 travels from the distal end of the feed tube 150, 250 into the driver shaft assembly for delivery to the work surface. A jaw assembly 500 is also provided for engaging the second end of the driver shaft assembly 300. The jaw assembly 500 is operable to receive the fastener 40 from the feed tube 150, 250. The jaw assembly 500 opens and closes in response to a control signal received from the shift assembly 180 or timing controller 236. Activating the power driver 110 delivers torque to a head of the fastener.

The driver shaft assembly can further comprise a handle and/or a coupler. The coupler secures the driver shaft assembly to the power driver 110. The handle can be positioned near the coupler and extend laterally from a long axis of the driver shaft assembly. Additionally, the feed tube 150, 250 can comprises a cap 212 and/or a flanged ring 216. The outer tube 164 can have a spring 166 that is coupled to the power driver 110 at a first outer tube end. An upper support 172 can also be provided that is coupled to a lower mount 178. Additionally, the upper support 172 can have a first support plate 173 with a first support plate aperture 174 and a second support plate 175 with a second support plate aperture 176.

A variety of jaw assemblies can be provided that control delivery of the fastener to the work surface. In one configuration, the jaw assembly 500 comprises a plurality of upper blades 504, 506, 508. The upper blades define a central jaw aperture 502 with an aperture size that is controllable by a plurality of corresponding upper blade controllers 522, 524, 526, 528. The jaw assembly can also include a plurality of lower blades corresponding to the upper blades that are controllable by a plurality lower blade controllers. One or more jaw springs 590, 592 can be provided that are operable to control a motion of the plurality of the upper blades.

A height adjustment mechanism 187 can also be provided to adjust space between the jaw assembly 500 and a work surface 30. The height adjustment mechanism 187 can further comprise an upper slide 188 and a lower slide 190 operable to slidingly engage the upper slide 188. A change in the orientation of the upper slide 188 and the lower slide 190 results in an increase or decrease in the length of the overall height of the adjustment mechanism 187. For example, when the lower slide 190 is moved in one direction the overall height of the adjustment mechanism 187 increases and when the lower slide 190 is moved in a second direction, opposite the first direction, the overall height of the adjustment mechanism 187 decreases.

A variety of nosepiece configurations can be provided that are operable to engage a work surface. For example, the nosepiece can have a flat distal surface or a pointed distal surface. Additionally an extension foot can be provided that is operable to provide a gap between the jaw and the work surface.

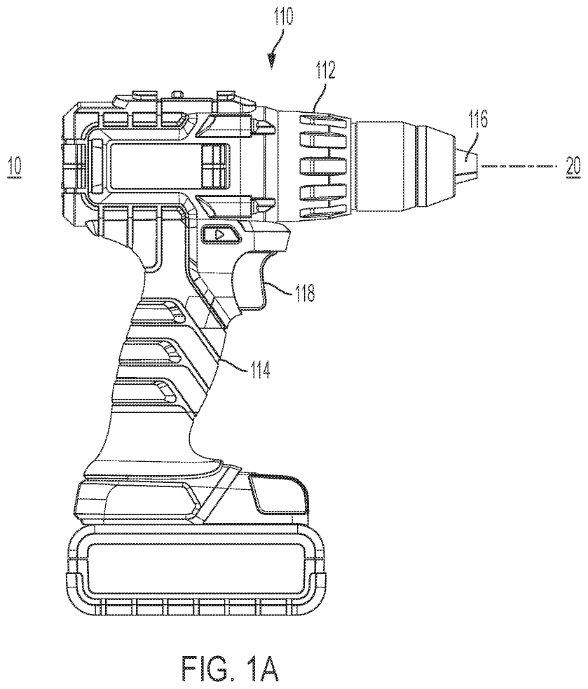

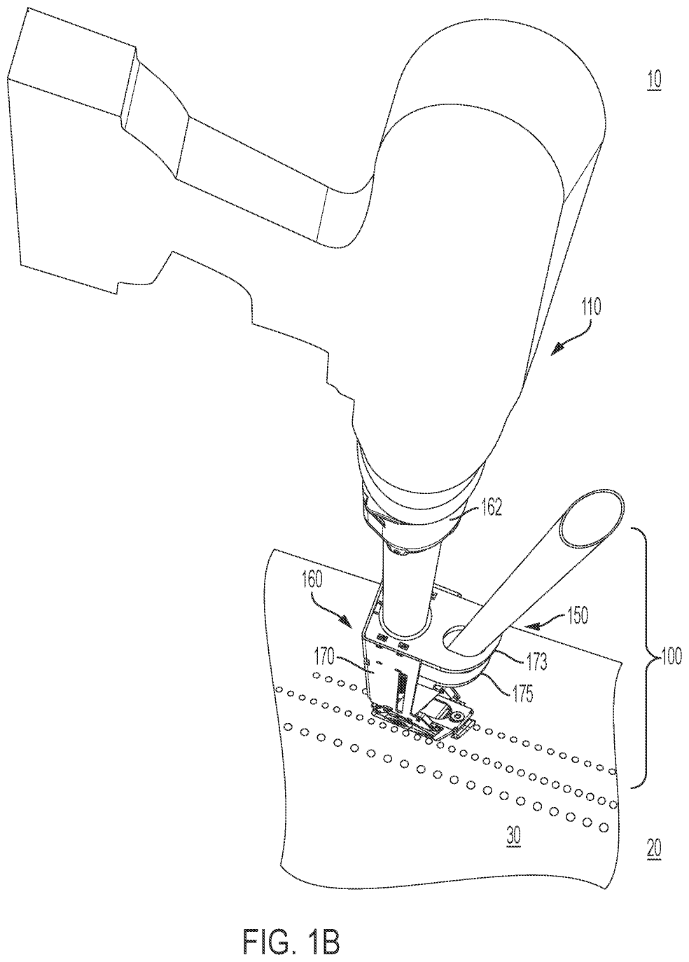

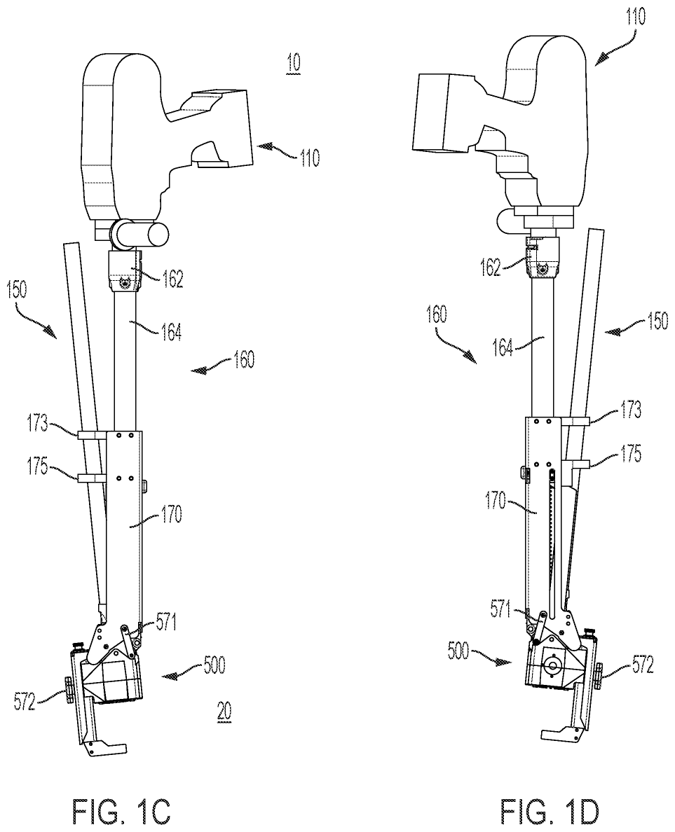

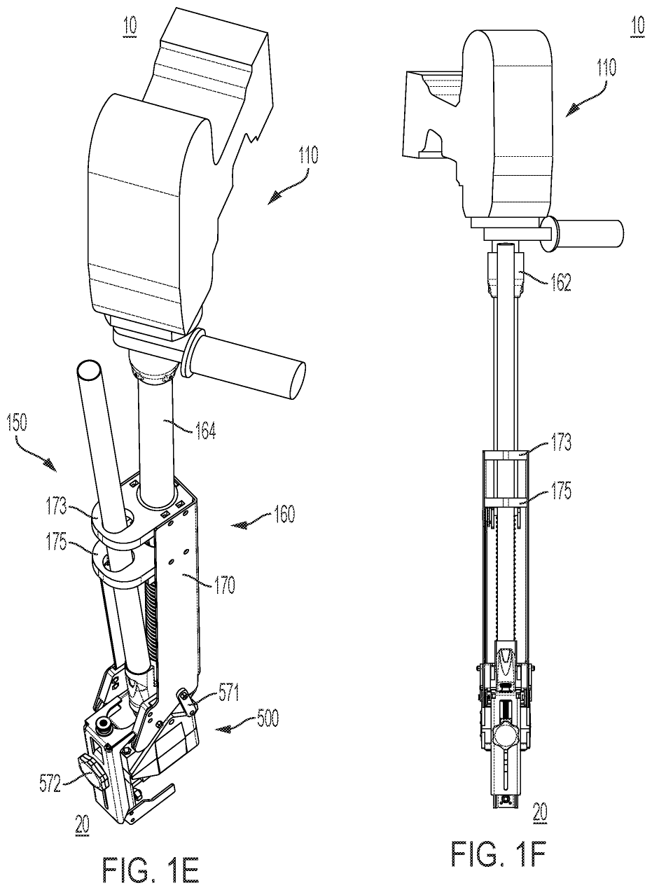

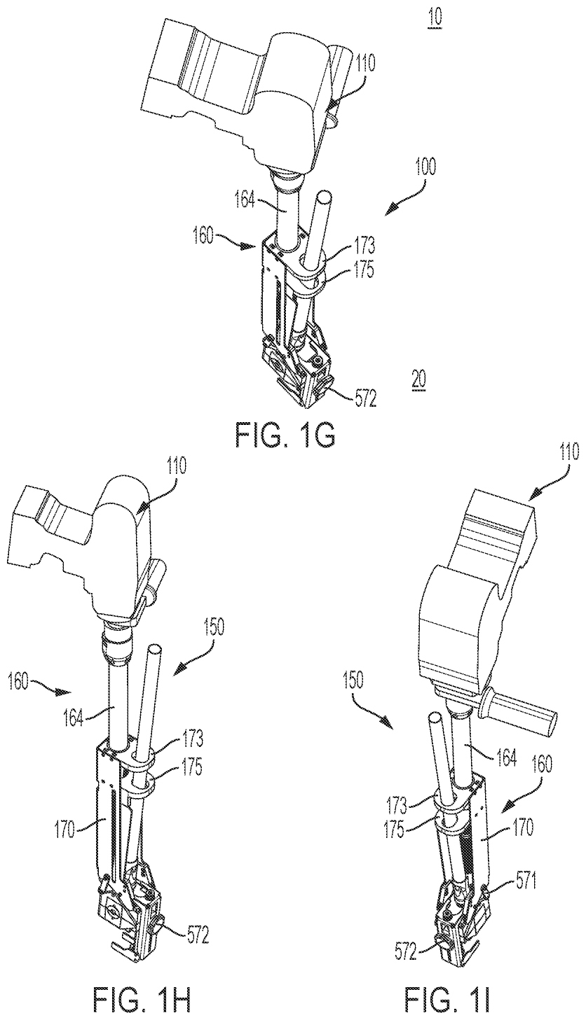

Turning now to FIG. 1A, the power driver 110 has a body 112 with a handle 114 and on/off controller 118 (e.g., trigger) and a chuck 116. The power driver 110 can be, for example, a drill or an impact driver. When a drill is used, the chuck 116 may have a collapsible jaw that is sized and configured to engage a shank of, for example, a drill bit. The power driver 110 is shown with a proximal end 10 and a distal end 20, where the proximal end is nearest the user and the distal end is nearest the work surface. For ease of reference, components of the system will be described with respect to a proximal end and a distal end. Where the distal end of one component engages the proximal end of the next component.

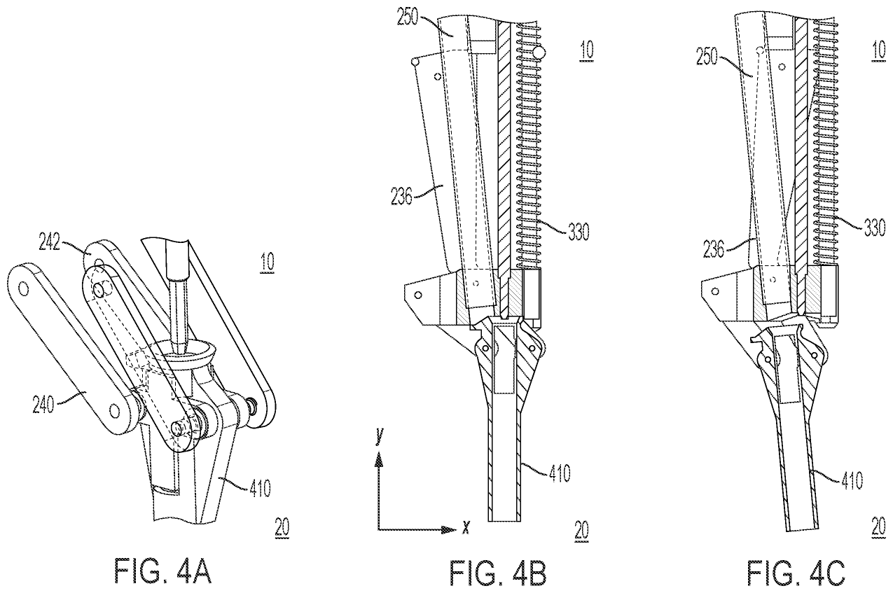

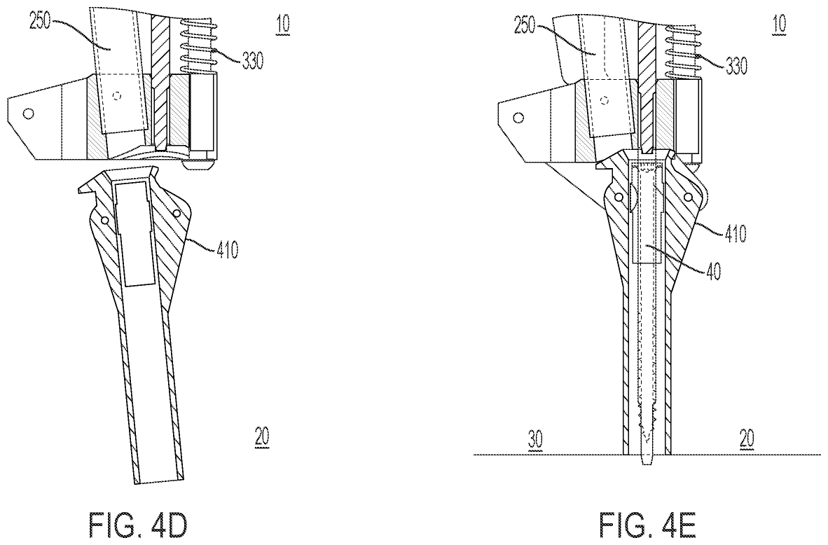

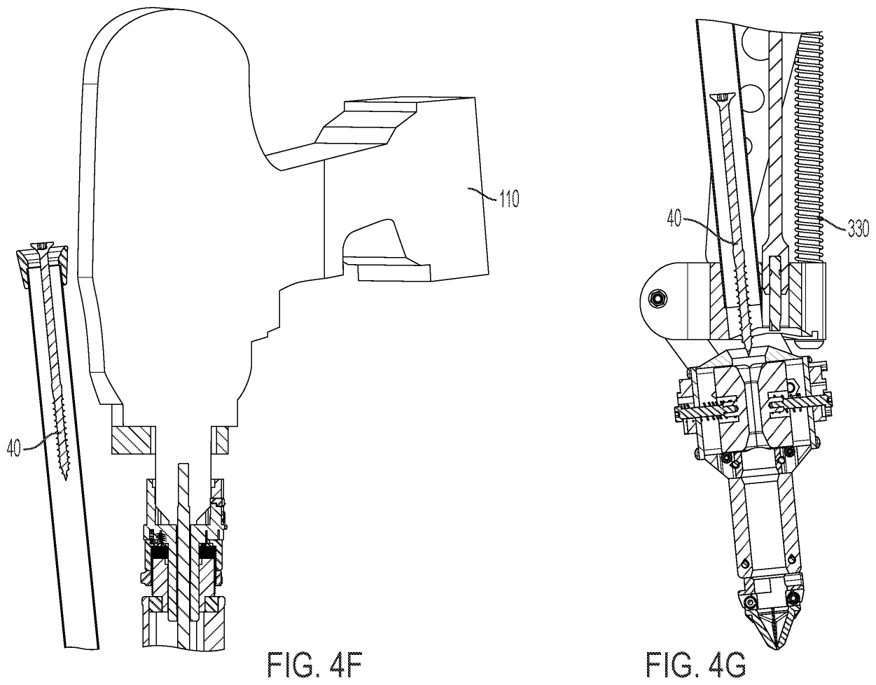

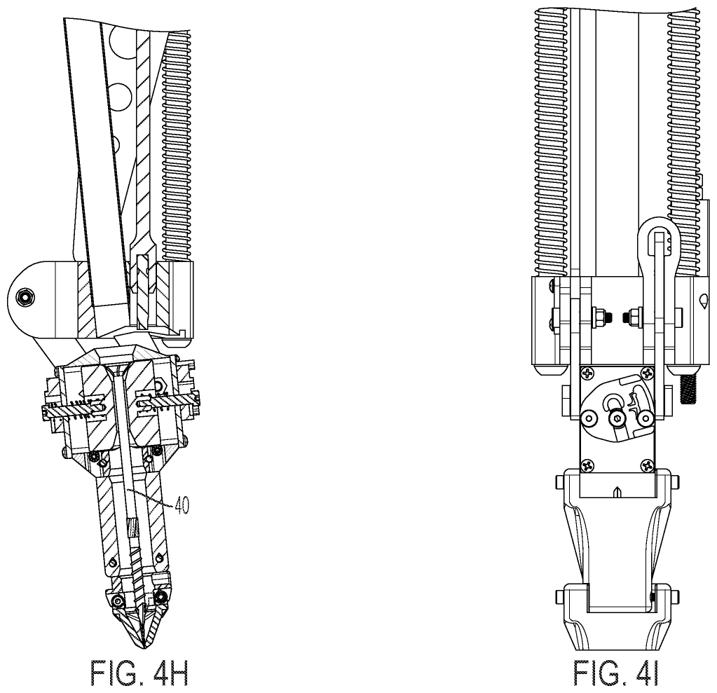

Turning now to FIG. 1B a power driver 110 is illustrated in combination with a fastener delivery tool 100 from an upper perspective facing a work surface. The fastener delivery tool 100 has a loading assembly and a driver shaft assembly 160. The power driver 110 operates the driver shaft assembly 160. A nosepiece (also shown in FIGS. 4-9) is positioned at the distal end 20 of the fastener delivery tool 100 and engages the work surface 30. As is appreciated by those skilled in the art, suitable fasteners have a head with a drive interface (e.g., shaped and operable to engage a bit), and a length. The length can be further separated into a shank portion and a thread length portion, where a threaded portion has a major diameter (corresponding to the crest or highest part of the thread), and a minor diameter. Each thread also has a thread angle and a pitch.

FIGS. 1C-1I illustrate the fastener delivery tool 100 from different angles. From the various angles, it will be appreciated that a fastener drops through the loading assembly 150 and into the jaw assembly 500. In some configurations, the fastener then passes through a gap between the jaw assembly 500 and nosepiece 700 before delivery to a work surface achieving a drop and catch process. However, a variety of nosepiece configurations can be used which do not include a drop and catch process without departing from the scope of the disclosure.

The first support plate 173 is positionable in a spaced relationship with the second support plate 175. A portion of the first support plate 173 and the second support plate 175 are positionable within an outer housing 170 positioned distally to the outer tube 164.

FIG. 1J is an exploded view of the fastener delivery tool 100. The driver shaft assembly 160 has an upper assembly that includes a screw gun mount 162 at a first end (proximal end) and a bit quick release at a second end (distal end). An outer tube 164 is provided with a spring 166 positioned within the outer tube 164. The screw gun mount 162 engages a first end of the outer tube 164. A lower stop 168 is provided at the opposing end of the outer tube 164. The lower stop 168 has a curved shape operable to surround at least a portion of the outer tube 164. A portion of the outer tube 164 fits within an outer housing 170. An upper support 172 is provided that is partially positioned within the outer housing 170. The upper support 172 has a first support plate 173 with a first support plate aperture 174 sized to engage the spring 166. A second support plate 175 is provided with a second support plate aperture 176. The second support plate 175 is positionable below the first support plate 173. A lower mount 178 is provided which is positionable below the second support plate 175. A tubular element 179 extends upwardly from the lower mount 178. The tubular element 179 is sized to fit within the first support plate aperture 174 and the second support plate aperture 176.

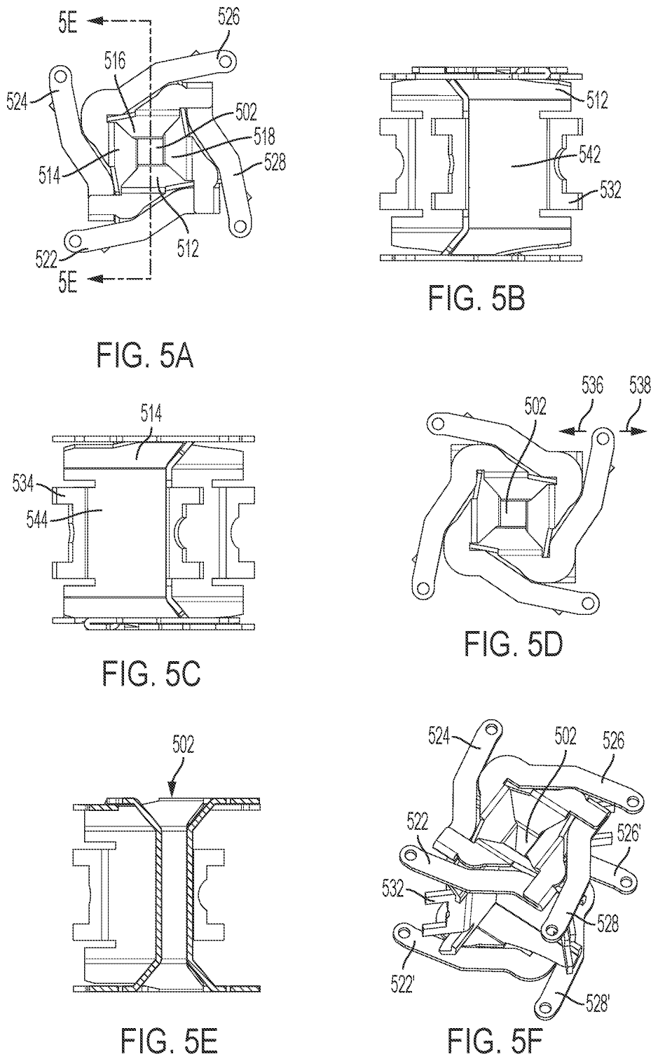

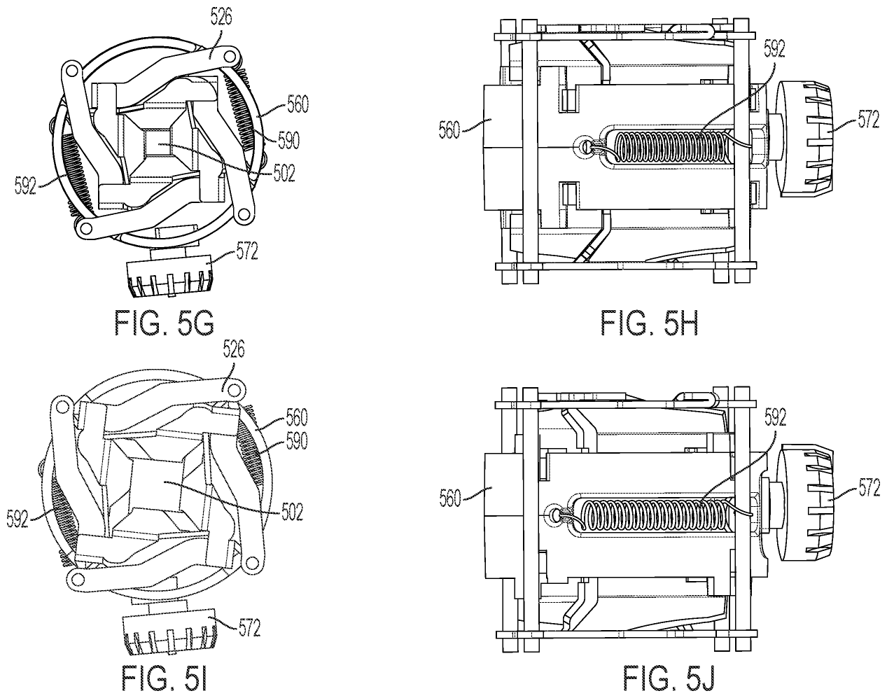

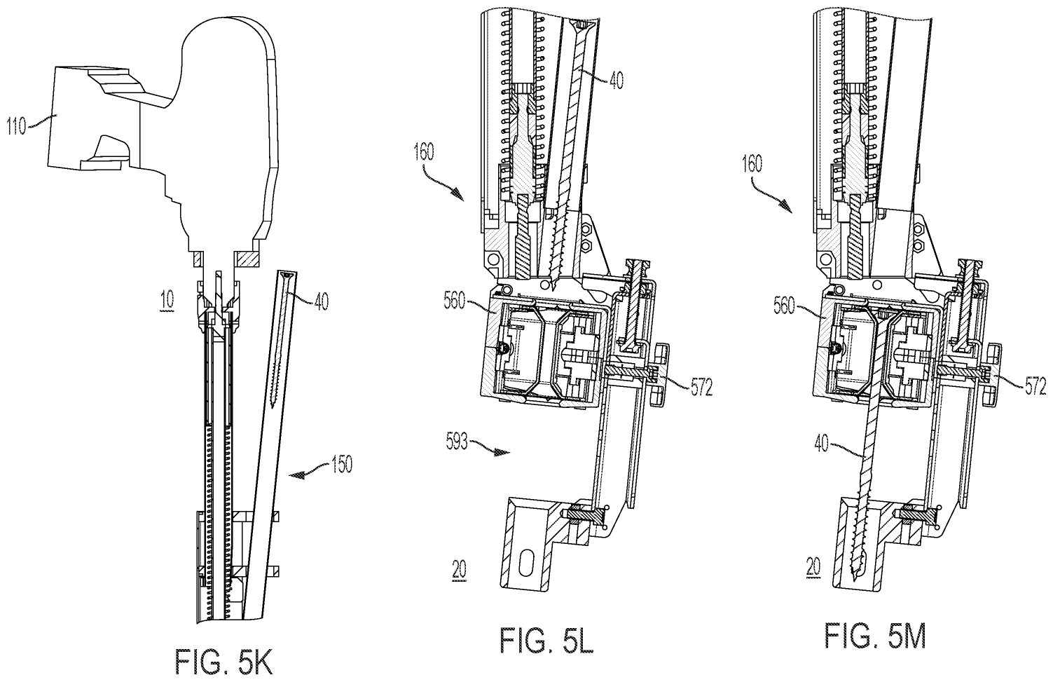

A shift assembly 180 is provided. The shift assembly 180 controls opening and closing of the jaw mechanism discussed below, as well as timing of the operation of the jaw. The shift assembly 180 has a first arm 181 that extends in a first direction on a first side of a shift assembly plate 183, and a second arm 182 that extends in the same first direction on a second side of the shift assembly plate opposite the first side. Both the first arm 181 and the second arm 182 have a curved aperture 184. The shift assembly plate 183 has a third arm 185 that extends in an opposite direction on a third side of the shift assembly plate perpendicular to the first side and the second side. A knob 186 is provided that secures the outer housing 170 and the second support plate 175. A height adjustment assembly is provided. The height adjustment assembly has two pieces. An upper L-shaped piece, upper slide 188, engages a lower slide 190. The upper slide 188 is an upper slide with a long side and a short side. The long slide has a wall on either side to create a recess. A flap 189 is provided at a 90 degree angle from the inside face of the long side of the L-shaped piece. The flap has a width that is narrower than the width of the upper slide 188. A lower slide 190 is provided that slidably engages the upper slide. The upper slide 188 can have a flange on that forms a recess in which the lower slide 190 nests and moves in a proximal and distal direction. The jaw assembly 500 assembly engages the upper jaw housing via the lower mount 178. The jaw assembly is illustrated and described in further detail in FIG. 5.

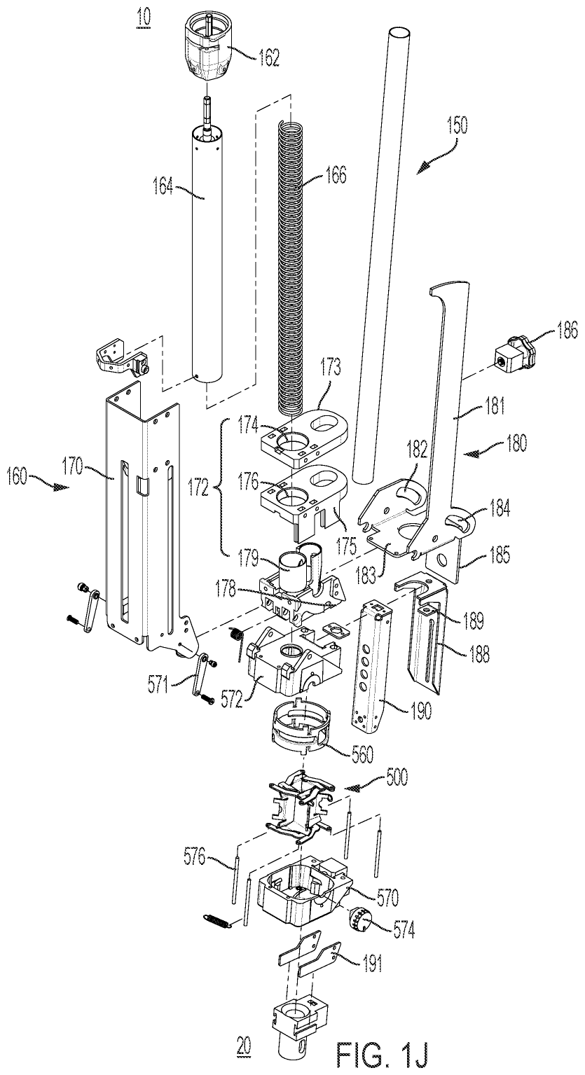

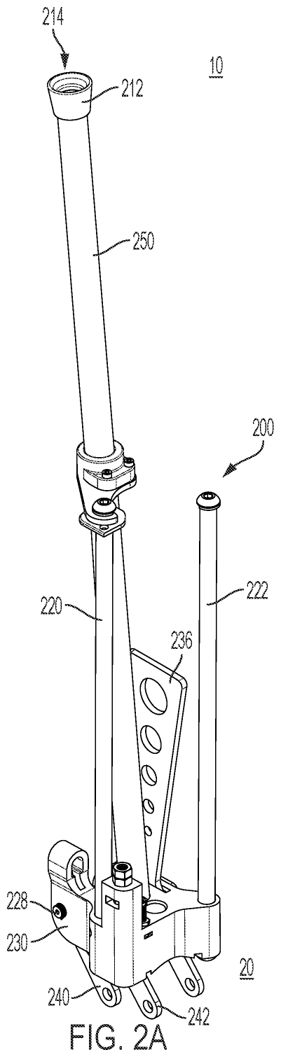

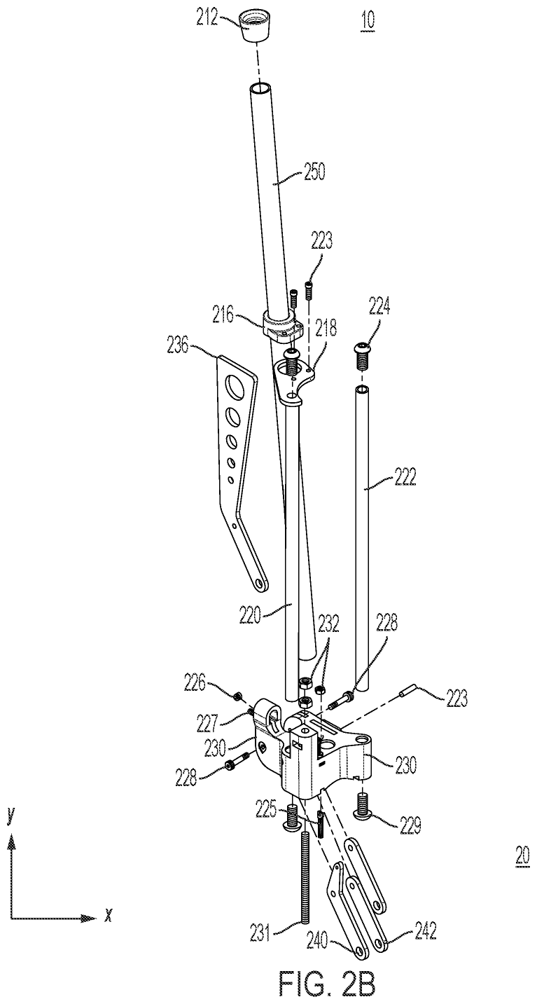

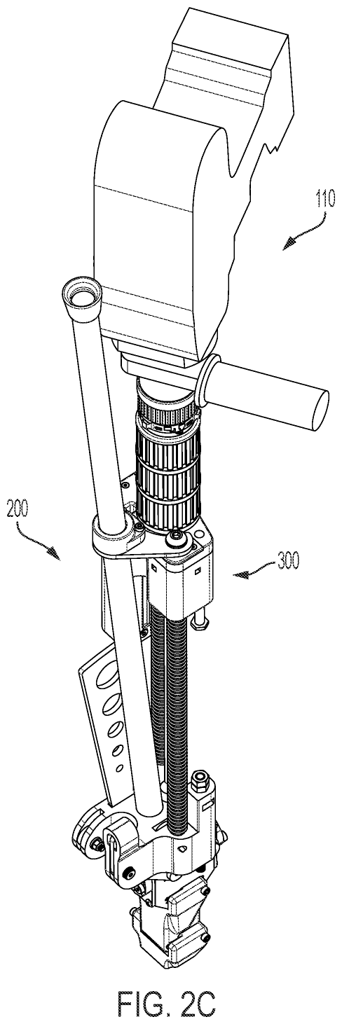

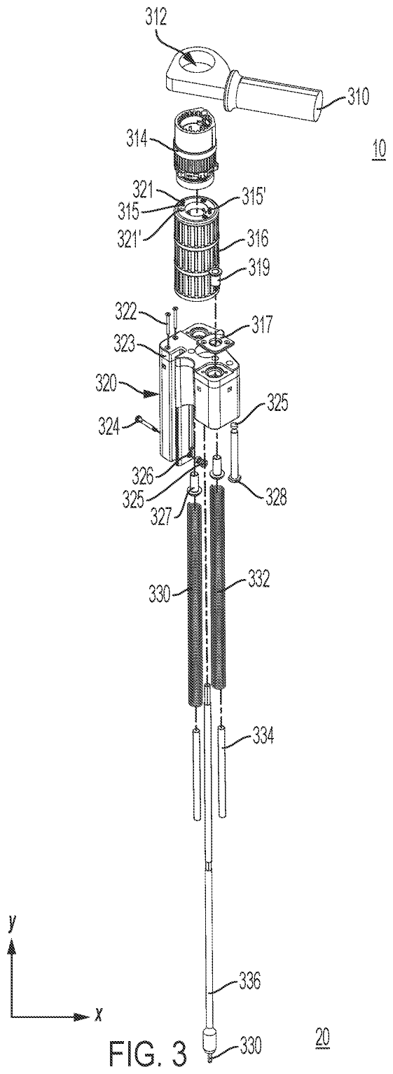

FIG. 2A illustrates a side partial perspective view of a loading assembly of a fastener delivery tool 200. FIG. 2B illustrates an exploded view of the loading assembly of the fastener delivery tool 200 shown in FIG. 2A. The loading assembly has a feed tube 250 with a cap 212 at a first end (proximal end). The cap 212 securely engages the feed tube 250 at the proximal end 10 of the feed tube 250. The cap 212 defines an aperture 214 through which a fastener (not shown) passes during use. A flanged ring 216 is provided to engage a first slider rail 220. The flanged ring 216 has an aperture that allows the flanged ring 216 to fit around the feed tube 250. The flange 218 of the flanged ring 216 extends away from the outer surface of the flanged ring 216. The flange 218 engages the first slider rail 220. A second slider rail 222 is provided. The first slider rail 220 and the second slider rail 222 fit within the springs of the driver shaft assembly 300 (shown in FIG. 3). A hex drive screw 224 and washer can be provided for each of the slider rails to secure the slider rails relative to the flanged ring 216 and the drive shaft assembly. The loading assembly base 230 can have flat upper surface and a plurality of apertures. A variety of securement mechanisms can be provided to engage the loading assembly base including one or more of any of the following: hex drive screw 223, machine screw style hangers 225, a hex lock nut 226 and washer 227, a shoulder screw 228, head hex drive screws 229. A high strength threaded rod 231 is also provided which passes through an aperture in the bottom surface of the loading assembly base 230 and is engaged at an upper end by a hex nut 232. A dowel 233 engages an aperture in the side of a loading assembly base 230.

In one configuration, a timing controller 236 is provided. As illustrated in this embodiment the timing controller 236 is a flat bar with an elbow bend and a plurality of apertures. The timing controller 236 has a longer end one a first side of the bend and a shorter end on the second side of the bend. During use, the timing controller 236 rotates about an axis to control the operation of the tool so that it stops or prevents the tool from compressing until the assembly is shifted into place (e.g., tool and the fastener to be driven) by moving towards and away from a longitudinal axis formed by, for example, the feed tube 210. The timing controller 236 is operable to control engagement of the bit with the fastener. Bent shaft 240 and two straight shafts 242 are provided which are operable to engage the fastener deliver tool and the nosepiece to control delivery of the fastener from the fastener delivery tool 200. The timing controller operates similarly to the shift assembly 180 shown in FIG. 1J.

FIG. 2C illustrates a fastener delivery tool configured as shown in FIGS. 2A-B with the power driver 110.

FIG. 3 is an exploded view of a driver shaft assembly 300 for a fastener delivery tool. The drive shaft assembly 300 has a handle 310 at a proximal end 10. The handle 310 is elongated with an aperture 312 through and end which is perpendicular to an axis along its length. A coupler 314 is provided which is sized at one end to fit within the aperture 312 if the handle 310. The second end of the coupler 314 engages a tubular member 316, which in turn engages a drive shaft assembly base 320. The tubular member 316 has, for example, a pair of socket cap screws 321, 321′ and screws 315, 315′. As with the fastener delivery tool 200, a variety of securement mechanisms can be provided to engage the body 323 of the drive shaft assembly base 320 including one or more of any of the following: a cap screw 322, a shoulder screw 324, and a hex nut 325. A bushing 319 can also be provided. A ball bearing 326 is provided, along with a pair of washers 327. A stopper bolt 328 is also provide, along with a pair of compression springs 330, 332. The compression springs 330, 332 are sized so that the first slider rail 220 and second slider rail 222 can pass through an aperture formed by the compression springs 330, 332. The compression springs 330, 332 (with the first slider rail 220 and the second slider rail 222) engage the loading assembly base 230 and the drive shaft assembly base 320. A pair of dowels 334 are provided which pass through a portion of the compression springs and slider rails. An elongated member 336 is provided which engages a bit 338. The bit 338 engages a fastener during use and the elongated member controls spinning of the bit 338 to drive the fastener into the work surface.

FIGS. 4A-E illustrate a portion of an exemplar loading tool or loading assembly illustrating an active shifting process for shifting the position of the fastener during the fastener loading process. As shown in FIG. 4B, the feed tube 210 is positioned at an angle from a y-axis. During operation, the receiving tube shifts as shown in FIG. 2C so that the feed tube 210 and the receiving tube 410 align, this allows the fastener to pass from the feed tube 210 into the receiving tube 410. From a starting position, the feed tube 210 and the receiving tube 410 are aligned. When the user lifts the tool off the work surface, springs return the tool to a fully open and rest position. With the feed tube 210 and receiving tube 410 aligned, the next fastener can be loaded. Thus, once the fastener has passed into the receiving tube, the feed tube and receiving tube return to their starting position so that the receiving tube, now containing the fastener, is aligned with the drive shaft assembly as shown in FIG. 2E.

Turning now to FIGS. 5A-J, a jaw assembly 500 is illustrated. The jaw assembly 500 is operable for use in a fastener-driving tool. The jaw assembly comprises a plurality of upper blades 512, 514, 516, 518 having an upper surface with a first portion and a second portion angled across a bend in the upper surface, an interior facing edge and an exterior facing edge wherein the interior facing edge of the plurality of upper blades defines a variably sized central jaw aperture 502. A plurality of upper blade controllers 522, 524, 526, 528 are also provided. The plurality of upper blade controllers 522, 524, 526, 528 engage an adjacent upper blade along a portion of the interior facing upper blade edge on a first side. Moreover, the plurality of upper blade controllers 522, 524, 526, 528 are positioned along an exterior edge of the corresponding upper blade. Each of the plurality of upper blades 512, 514, 516, 518 engages an adjacent upper blade controller 522, 524, 526, 528 along a portion of the interior facing upper blade edge on a first side, and is positioned along an exterior edge of the upper blade.

Thus, for example, upper blade 514 has an upper blade controller 524 that extends from a portion of the interior facing blade edge of adjacent upper blade 512 and extends along an exterior edge of the upper blade 514. A jaw mount 560 substantially surrounds the plurality of upper blades and upper blade controllers. Additionally, a pair of jaw springs 590, 592 is provided that are operable to control a motion of the plurality of upper blades.

In operation, the jaw assembly 500 is operable to receive a fastener 40 from a feed tube. The point and shank of the fastener are allowed to pass through and the fastener comes to rest when the head of the fastener lands on the blades 522, 524, 526, 528. The bit engages with the fastener and eventually pushes the fastener through the jaw assembly 500. Consequently, the fastener can force the jaw assembly to open, typically at the head. The jaw assembly 500 further comprises a plurality of lower blades controllable by a plurality lower blade controller, which can also be controllable by the springs.

As will be appreciated by those skilled in the art, upper blades 512, 514, 516, 518 each have an edge that engages with the adjacent member. For example, as shown in FIG. 5A the upper surface of upper blade 514 pushes on a left surface of upper blade 516. When one upper blade is pushing outward, from a central axis, the movement of the upper blade causes the adjacent upper blade to move in the same manner. Thus, the movement of one upper blade in an outward direction causes the remaining upper blades to move outward at the same time. Similarly, if an upper blade moves inward, the remaining upper blade will move in the same manner. Moving all of the upper blades in the same way maintains the same center axis for the variably sized central jaw aperture 502. The upper blades 512, 514, 516, 518 pivoting about the apertures located at the end of the upper blade controllers 522, 524, 526, 528.

From an upper view shown in FIG. 5A, the jaw assembly 500 has a plurality of upper blades 512, 514, 516, 518. The plurality of upper blades 512, 514, 516, 518 are controlled by a corresponding upper blade controller 522, 524, 526, 528. When the blade controller is moved in a first direction 536, the central jaw aperture 502 gets smaller, thereby preventing the entire fastener from passing through the jaw assembly 500. As will be appreciated by those skilled in the art, the shank and threaded portion of the fastener can pass through the jaw assembly, but the head of the fastener is unable to pass through without application of force from above to move the fastener in a distal direction toward the work surface. Conversely, if the fastener is partially driven into the work surface and sitting proud (e.g., raised) of the work surface, the device can be positioned over the fastener and pushed distally so that the head of the fastener forces the jaws to open and allows the bit to engage the fastener prior to reversing the fastener from its current location (i.e., moving the fastener proximally). When the blade controller is moved in a second direction 538, the central jaw aperture 502 gets larger. As appreciated from FIGS. 5B-C, the blades have a sidewall 542, 544. The sidewall 542, 544 has flanges 532, 534 that extend laterally away from the surface of the sidewall. The flanges 532, 534 engage with the jaw mount 560 which is able to rotate and is spring loaded. The rotation and loaded spring is operable to return the blades to a rest position. A second, lower set of blades can also be provided on the opposite end of the sidewall from the first, upper blades 512, 514, 516, 518. The length of the sidewall can be varied to accommodate the length of a fastener. Additionally, the plurality of upper blades can form an angled surface to the sidewall as shown in FIG. 5E, allowing for a tapered head of a fastener to nest against an upper facing surface of the upper blades.

The knob 572 is operable to adjust the jaw assembly allowing the device to optimally perform with fasteners of different dimensions. Thus, for example, turning the knob 572 in a first direction will facilitate operating the jaw assembly with a fastener having a first diameter and turning the knob 572 in a second direction, opposite the first direction, will facilitate operating the jaw assembly with a fastener having a second diameter different that the first diameter. As will be appreciated by those skilled in the art, the knob 572 can be turned incrementally in a first direction, or second direction, to optimize performance with fasteners having increasing diameter (e.g., incremental movement in a first direction) or smaller diameters (e.g., incremental movement in a second direction, opposite the first direction).

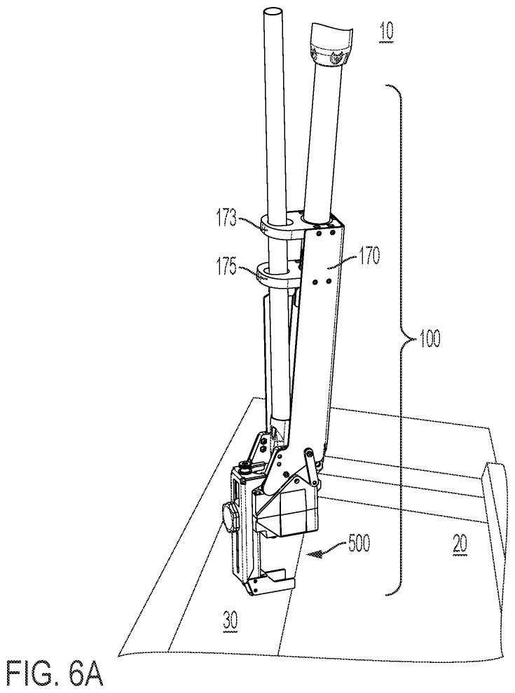

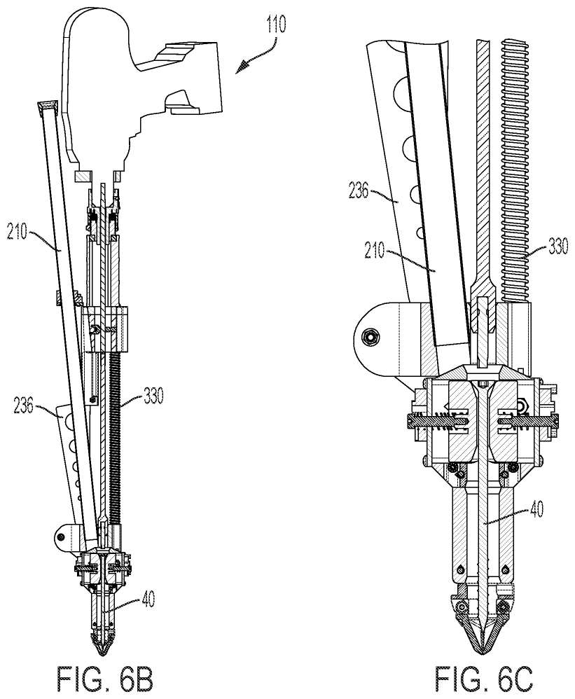

FIG. 6 illustrates the fastener delivery tool 100 engaging a work surface 30. FIGS. 6B-C illustrate a partial cross-section (and close-up) of the delivery tool with a fastener 40 ready for delivery to the installation surface.

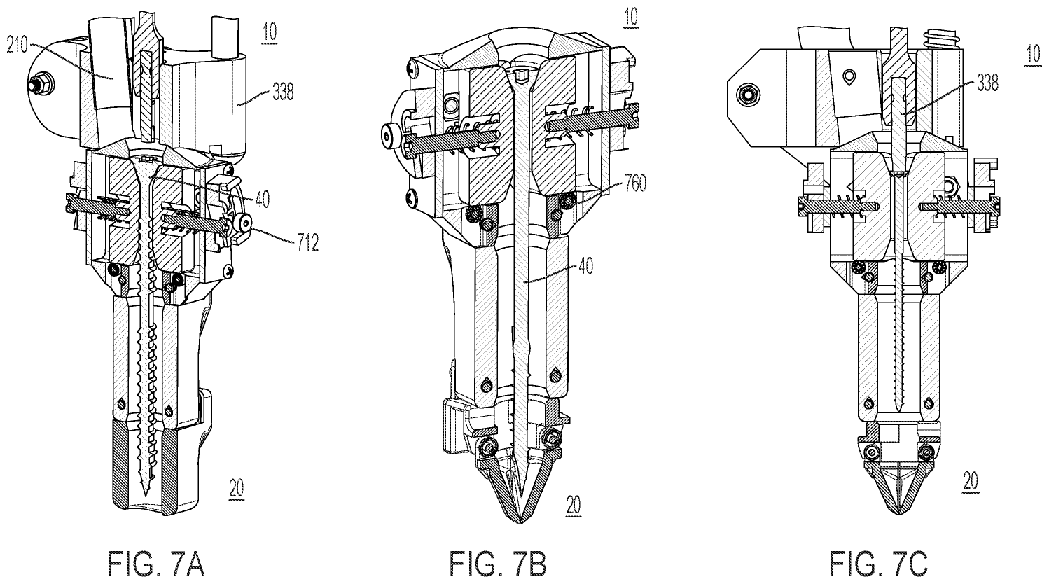

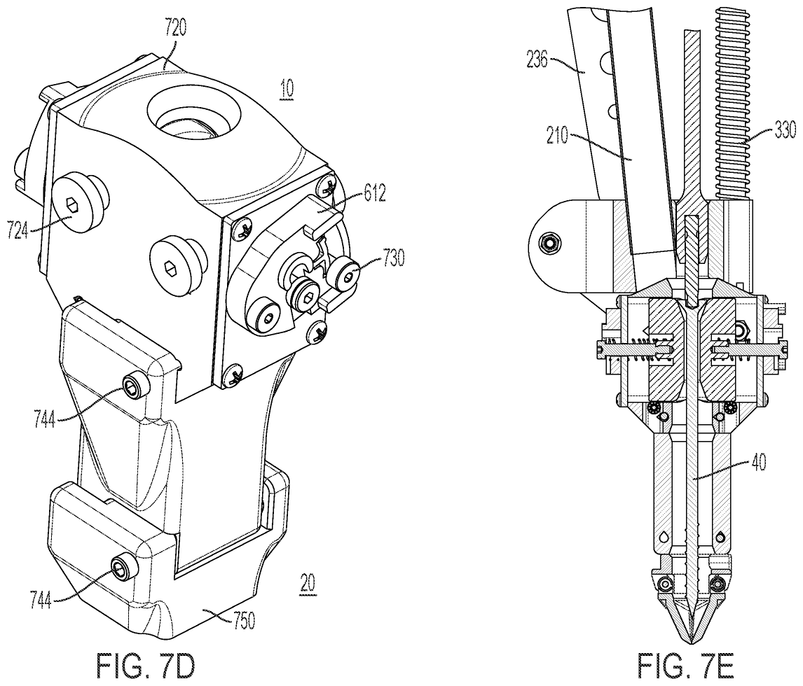

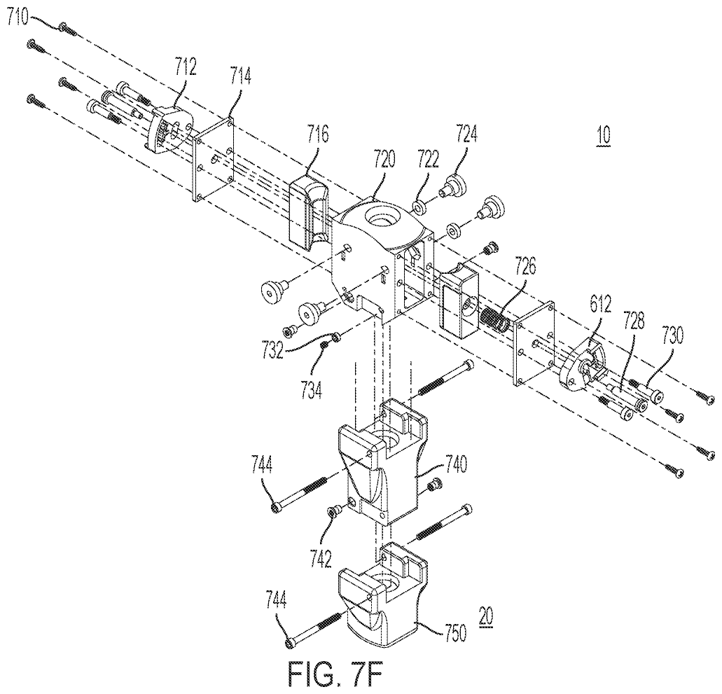

FIGS. 7A-F illustrate nosepieces 700 for the fastener delivery tools including partial cross-sections, an external view, and an exploded view. Some nosepieces 700 have a flat work surface interface (e.g., FIG. 7A) while other configurations have an angled work surface interface or bird beak interface (e.g., FIG. 7B).

The nosepiece 700 has a central block 720 with an aperture that passes through the central block that is operable to receive a fastener during use. The central block 720 has a pair of fastener release elements 716 or jaws on either side that are configured to move towards a central axis passing through the central block 720. The aperture is in communication with the feed tube to receive the fastener. Each fastener release element is coupled to a plate 714 and a fastener release controller 712 or toggle. The fastener release elements 716 have an angled surface at an upper end to engage the head of a fastener during use.

A compression spring 726 is provided. Plate 714 is stationary while the fastener release elements 716 move. The compression spring 726 pushes the fastener release elements 716 inward towards the central axis. The fastener release controller 712 determines how close the opposing jaws get at rest. Thus, for a larger diameter screw, the fastener release controller 712 is set so that the jaws are further apart at rest. For smaller diameter screws, the fastener release controller 712 is set to allow the jaws to come closer together at rest. When the screw head and the driver bit pass through, the jaws slide open and are then out of the way. Jaw fastener 728 is threaded into the jaw piece. Fastener release controller 712 interacts with jaw fastener 728, e.g. by toggling, which in turn determines the jaw position.

A plurality of fastening devices are provided to secure the components of the nosepiece 700 together. Suitable fastening devices include one or more screws 710, one or more socket cap screws 730, and one or more knurled inserts for hardwood 742. An upper guide 740 and a lower guide 750 is provided. Each of the upper guide 740 and a lower guide 750 have an aperture that passes through each guide that is operable to receive the shaft of the fastener during use. The lower guide 750 is shaped at its distal end 20 to have either a flat surface or an angled beak surface as desired.

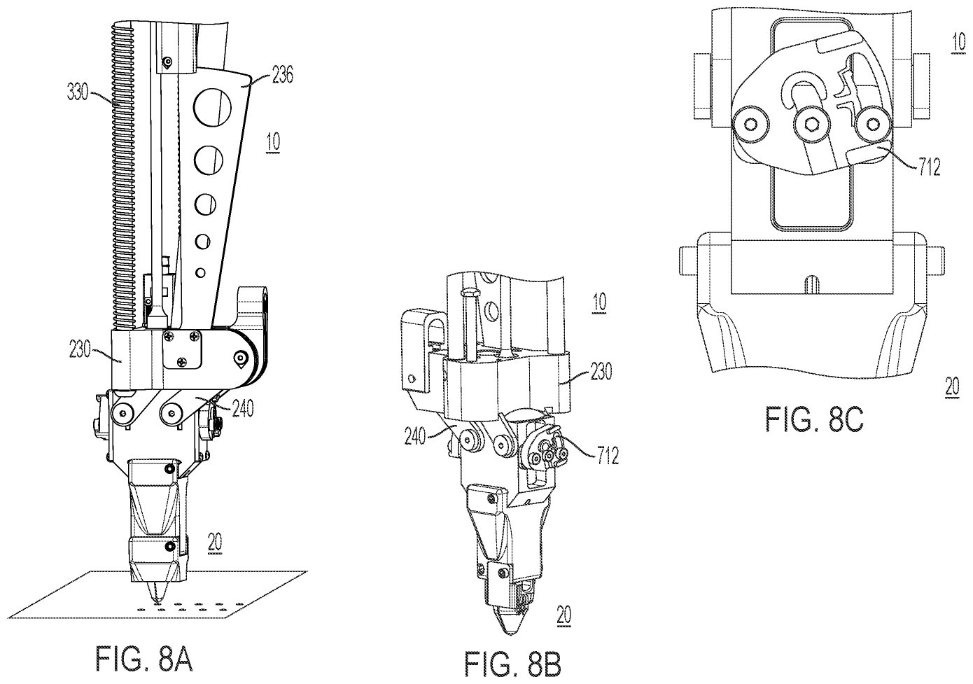

FIGS. 8A-C illustrate the angled worked surface interface for the fastener delivery tool.

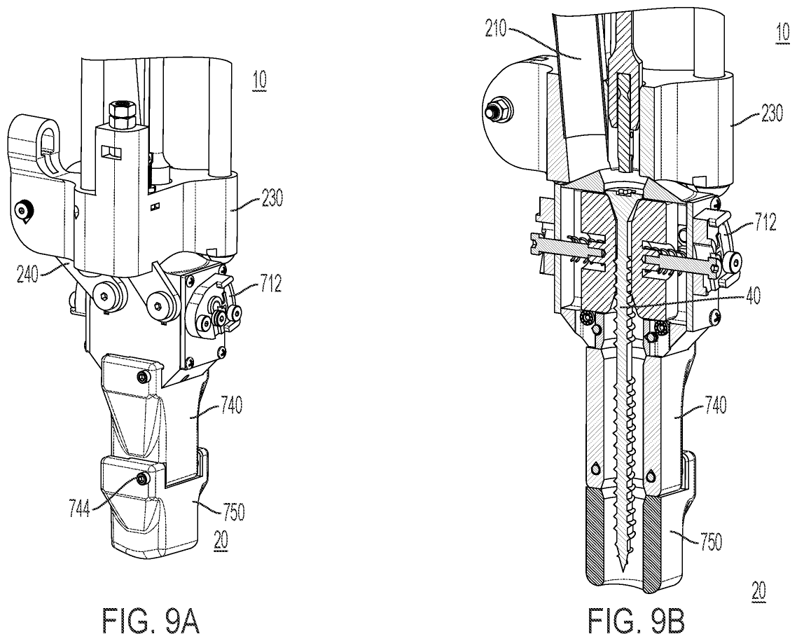

FIGS. 9A-B illustrate the flat work surface interface for the fastener delivery tool.

While standing, a user drops a fastener into the drop tube with the point of the fastener facing distally (away from the user and towards the work surface). If the fastener is placed into the drop tube in correctly (i.e., head of the fastener positioned distally), the fastener is easily removed by inverting the device. Additionally the fastener release controller 712 when activated would not fully close around the fastener because the head of the fastener would not be positioned at the proximal end of the fastener release controller 712 in the recessed area.

When the user starts to activate the device, to drive a fastener into a work surface, a four bar mechanism turns vertical movement into rotation of the nose (see, for example, FIG. 4). Active rotation of the nose is used to result in a shifting motion. A separate actuator does not create the shifting. Instead, the shifting is created by the normal driving action when operating the device. In an alternative embodiment, the actuator can be a cable or level that achieve the shifting movement.

Once the fastener passes from the feed tube into the nosepiece, the fastener is positioned between two jaws that support the fastener most of the way around. The fastener is captured under the head instead of at a point for improvement alignment with the bit. Placing downward pressure on the device to drive the fastener makes it harder for the jaws of the nosepiece to open enough for the head of the fastener to pass through the central aperture. Rollers 760 are added to address this issue. Additionally, the jaws are configured to allow the tool to be lifted off the work surface without dropping the fastener. The stroke of the jaws is also operable to allow the head of the fastener to full clear the device while also being able to securely engage fasteners with a smaller head. The fastener release controller 712 makes the jaw spacing adjustable. As noted above, the driving motion shifts the fastener into a drive position. To control this process the bit engagement is timed to avoid jams. The timing controller controls the timing of the bit engagement.

In some applications, locating holes in a steel strap or steel plate is necessary. For installations that require locating holes the tapered (beak) interface further facilitates accurate use of the device and increases precision. The jaws of the beak are operable to open at the same time. The modular nature of the nosepiece allows the length to be changed (e.g., by removing the upper guide) to accommodate fasteners of shorter length.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein might be employed in practicing the invention. It is intended that the claims define the scope of the invention and that methods and structures within the scope of these claims and their equivalents be covered thereby.

What is claimed:

1. A fastener driving tool comprising:
a loading assembly comprising a feed tube operable to receive a fastener at a first end and deliver the fastener at a second end;
a driver shaft assembly operable to engage a power driver at a first driver shaft assembly end and receive the fastener from the feed tube;
a timing controller operable to control engagement of a bit; and
a jaw assembly engaging the second end of the driver shaft assembly wherein the jaw assembly.

2. The fastener driving tool of claim 1 wherein the driver shaft assembly further comprises one or more of a handle and a coupler.

3. The fastener driving tool of claim 1 wherein the feed tube further comprises one or more of a cap, and a flanged ring.

4. The fastener driving tool of claim 1 further comprising an outer tube with a spring positioned therein coupled to the power driver at a first outer tube end.

5. The fastener driving tool of claim 1 further comprising an upper support coupled to a lower mount.

6. The fastener driving tool of claim 5 wherein the upper support has a first support plate with a first support plate aperture and a second support plate with a second support plate aperture.

7. The fastener driving tool of claim 1 wherein the jaw assembly further comprises a plurality of upper blades controllable by a plurality of corresponding upper blade controllers.

8. The fastener driving tool of claim 7 wherein the jaw assembly further comprises a plurality of lower blades controllable by a plurality lower blade controllers.

9. The fastener driving tool of claim 7 further comprising one or more jaw springs operable to control a motion of the plurality of the upper blades.

10. The fastener driving tool of claim 1 further comprising a height adjustment assembly.

11. The fastener driving tool of claim 10 wherein the height adjustment assembly further comprises an upper slide and a lower slide operable to slidingly engage the upper slide.

12. The fastener driving tool of claim 1 further comprising a nosepiece operable to engage a work surface.

13. The fastener driving tool of claim 12 wherein the nosepiece has a flat distal surface or a pointed distal surface.

14. The fastener driving tool of claim 12 further comprising an extension foot operable to provide a gap between the jaw assembly and the work surface.

15. The fastener driving tool of claim 1 further comprising a fastener release controller.

16. A fastener driving tool comprising:
a loading assembly comprising a feed tube operable to receive a fastener at a first end and deliver the fastener at a second end;
a driver shaft assembly operable to engage a power driver at a first driver shaft assembly end and receive the fastener from the feed tube;
a jaw assembly engaging the second end of the driver shaft assembly wherein the jaw assembly operable to receive the fastener from the feed tube and open and close; and
a knob operable to adjust operation of the jaw assembly.

17. The fastener driving tool of claim 16 wherein the driver shaft assembly further comprises one or more of a handle and a coupler.

18. The fastener driving tool of claim 16 wherein the feed tube further comprises one or more of a cap, and a flanged ring.

19. The fastener driving tool of claim 16 further comprising an outer tube with a spring positioned therein coupled to the power driver at a first outer tube end.

20. The fastener driving tool of claim 16 further comprising an upper support coupled to a lower mount.

21. The fastener driving tool of claim 20 wherein the upper support has a first support plate with a first support plate aperture and a second support plate with a second support plate aperture.

22. The fastener driving tool of claim 16 wherein the jaw assembly further comprises a plurality of upper blades controllable by a plurality of corresponding upper blade controllers.

23. The fastener driving tool of claim 22 wherein the jaw assembly further comprises a plurality of lower blades controllable by a plurality lower blade controllers.

24. The fastener driving tool of claim 22 further comprising one or more jaw springs operable to control a motion of the plurality of the upper blades.

25. The fastener driving tool of claim 16 further comprising a height adjustment assembly.

26. The fastener driving tool of claim 25 wherein the height adjustment assembly further comprises an upper slide and a lower slide operable to slidingly engage the upper slide.

27. The fastener driving tool of claim 16 further comprising a nosepiece operable to engage a work surface.

28. The fastener driving tool of claim 27 wherein the nosepiece has a flat distal surface or a pointed distal surface.

29. The fastener driving tool of claim 27 further comprising an extension foot operable to provide a gap between the jaw assembly and the work surface.

30. The fastener driving tool of claim 16 further comprising a fastener release controller.

31. A jaw assembly operable for use in a fastener driving tool comprising:
a plurality of upper blades having an upper surface with a first portion and a second portion angled across a bend in the upper surface, an interior facing edge and an exterior facing edge wherein the interior facing edge of the plurality of upper blades defines an variably sized aperture;
a plurality of upper blade controllers wherein each of the plurality of upper blades engages an adjacent upper blade controller of the upper blade controllers along a portion of the interior facing upper blade edge on a first side, and is positioned along an exterior edge of the upper blade;
a jaw mount substantially surrounding the plurality of upper blades and upper blade controllers; and
a pair of springs operable to control a motion of the plurality of upper blades.

32. The jaw assembly of claim 31 wherein the jaw assembly operable to receive a fastener from a feed tube and open and close.

33. The jaw assembly of claim 31 wherein the jaw assembly further comprises a plurality of lower blades controllable by a plurality lower blade controllers.

34. The jaw assembly of claim 33 wherein the lower blade controllers are operable to control a motion of the plurality of the lower blades.

35. A method of installing a fastener comprising:
providing a fastener driving tool comprising a loading assembly comprising a feed tube operable to receive a fastener at a first end and deliver the fastener at a second end, a driver shaft assembly operable to engage a power driver at a first driver shaft assembly end and receive the fastener from the feed tube, and a jaw assembly engaging the second end of the driver shaft assembly wherein the jaw assembly is operable to open and close to receive the fastener from the feed tube;
placing a distal end of the fastener driving tool on a work surface;
inserting the fastener into the feed tube;
receiving the fastener into the jaw assembly of the fastener driving tool; and
activating the power driver to deliver torque to a head of the fastener.

36. The method of claim 35 wherein the fastener driving tool further comprises a knob further comprising the step of turning the knob in a first direction to adjust the jaw assembly based on a diameter of the fastener.

37. The method of claim 35 wherein the fastener driving tool further comprises a timing controller operable to control engagement of a bit further comprising moving the timing controller in a first direction to engage the bit and a second direction to disengage from the bit.
